(19) United States
(12) Patent Application Publication
(10) Pub. No.: US 2025/0335174 A1
(43) Pub. Date: Oct. 30, 2025

(54) DYNAMIC AND CONTEXTUAL LIFECYCLE MANAGEMENT OF MANAGED NODES

(71) Applicant: DELL PRODUCTS L.P., Round Rock, TX (US)

(72) Inventors: Parmeshwr Prasad, Bangalore (IN); Ravishankar Nanjundaswamy, Bangalore (IN); Shrinidhi Katte, Bangalore (IN)

(21) Appl. No.: 18/650,771

(22) Filed: Apr. 30, 2024

(51) Int. Cl. G06F 8/65; G06F 9/445

(52) U.S. Cl. CPC G06F 8/65; G06F 9/445

(57) ABSTRACT

An information handling system includes a memory to store machine-executable code and a processor to execute code. The processor creates a listing of a plurality of management functions, receives a subset of the management functions, and creates an execution script based on the subset of the management functions.

### FIELD OF THE DISCLOSURE

This disclosure generally relates to information handling systems, and more particularly relates to the dynamic and contextual lifecycle management of managed nodes of information handling systems.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may create a listing of management functions, receive a subset of the management functions, and create an execution script based on the subset of the management functions.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating a lifecycle management system according to an embodiment of the present disclosure;

FIG. 2 is a flowchart illustrating a method for dynamic and contextual lifecycle management of managed nodes of information handling systems according to an embodiment of the present disclosure; and

FIG. 3 is a block diagram illustrating a generalized information handling system according to another embodiment of the present disclosure;

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

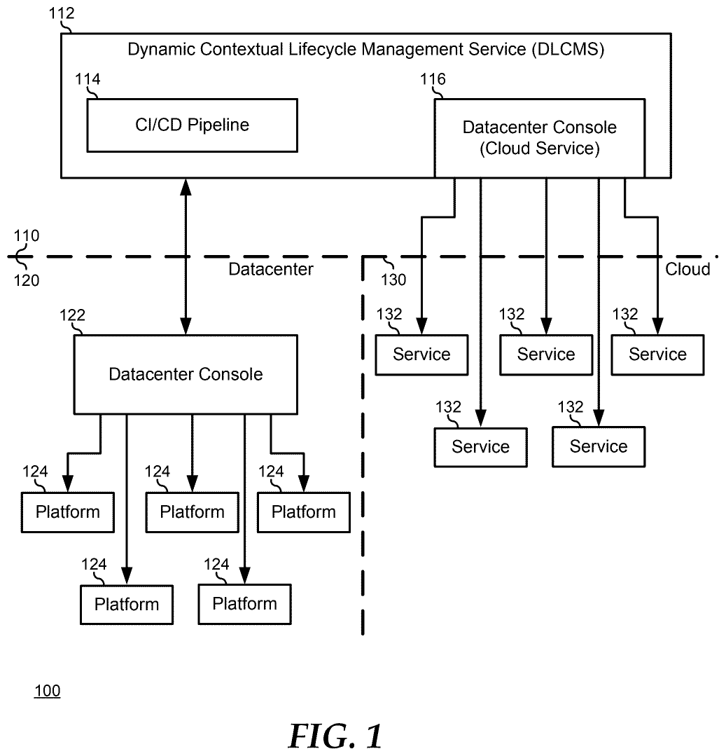

FIG. 1 illustrates a lifecycle management system 100. Lifecycle management system 100 represents a system form managing the lifecycles of various elements of managed environments. In particular, lifecycle management system 100 may provide lifecycle management for hardware elements, software elements, firmware elements, or other elements of the managed environments, as needed or desired. In a particular embodiment, lifecycle management system 100 represents a system established by a vendor or manufacturer of information handling systems, such as the information handling systems utilized in datacenters, corporate information technology networks, personal computers, or the like. As such, lifecycle management system 100 represents a centralized system for managing multiple managed environments to the benefit of the operators of the managed environments. Such centralized management benefits the operators in that the overhead of maintaining the elements of their environments can be provided by the operator of lifecycle management system 100, and such overhead is thereby shared among the various managed environments.

The elements that are managed by lifecycle management system 100 may include hardware devices. Lifecycle management may be understood to include recommendations for the replacement or upgrading of the hardware devices due to the availability of suitable replacement hardware devices, due to the expected obsolescence of the hardware devices, due to the expected failure of the hardware devices based on an analysis of the operating conditions of the hardware devices, or due to previously established upgrade plans or the part of the operator of the managed environments. In another case, the elements managed by lifecycle management system 100 may include firmware resident on various hardware devices. Here, lifecycle management may be understood to include the provision of firmware updates due to planned upgrades to the firmware, due to security holes identified in previous versions of the firmware, due to firmware recovery needs of the hardware devices, or the like. In another case, the elements managed by lifecycle management system 100 may include software, utilities, applications, programs, or the like that are utilized by the operator of the managed environments. Here, lifecycle management may be understood to include software updates to improve the functionality of the software, to patch security holes in the software, or the like.

Lifecycle management system 100 includes a management environment 110 that operates a centralized dynamic contextual lifecycle management service (DLCMS) 112 that manages one or more datacenter 120 and one or more cloud environment 130. Datacenter 120 includes a datacenter console 122 that communicates with DLCMS 112 to receive lifecycle management updates for various platforms 124 of the datacenter. As such, datacenter console 122 represents a centralized interface provided within the hardware resources of datacenter 120 that receives the lifecycle updates and distributes the lifecycle updates to platforms 124. For example, datacenter console 122 may be instantiated in a dedicated server system of datacenter 120, in a separate management system of the datacenter, as a distributed capability among several servers or management systems of the datacenter, or a combination thereof. In this regard, lifecycle management may be understood to include hardware lifecycle management, firmware lifecycle management, software lifecycle management, or the like. Cloud environment 130 includes various services 134 provided on the cloud and that a service 132 that communicate with DLCMS 112 to receive lifecycle management updates for the services, as described below. In this case, lifecycle management may be software lifecycle management, or the like.

It has been understood by the inventors of the current embodiments that the provision of lifecycle management services by a vendor or manufacturer of information handling systems typically involves the provision of generic or common feature sets for all customer platforms or services. In particular, lifecycle management updates are typically made up of extensive scripts that implement updates to the complete range of hardware, firmware, or software of the platforms or services. Even when a particular lifecycle management update is targeted to only hardware, firmware, or software, the scripts may be extensive, and include updates to functionality or features of the associated hardware, firmware, or software that are not of interest or are seldom utilized by the customer. Nevertheless in the typical lifecycle management scenario, the customer is not provided with any insight into the granularity of the lifecycle management service, and so must allocate extensive resources to the provision of lifecycle management updates for their platforms or services.

DLCMS 112 includes a continuous integration/continuous deployment (CI/CD) pipeline 114 and a cloud service datacenter console 116. In a particular embodiment, DLCMS 112 provides a hierarchical representation of lifecycle functionalities as a repository of code, which is integrated with CI/CD pipeline, such that update modules generated by the CI/CD pipeline are provided to the customer premises (i.e., datacenter 120 and cloud environment 130) based on customer preferences for lifecycle management update schedules and personalization of the features included in the lifecycle management updates.

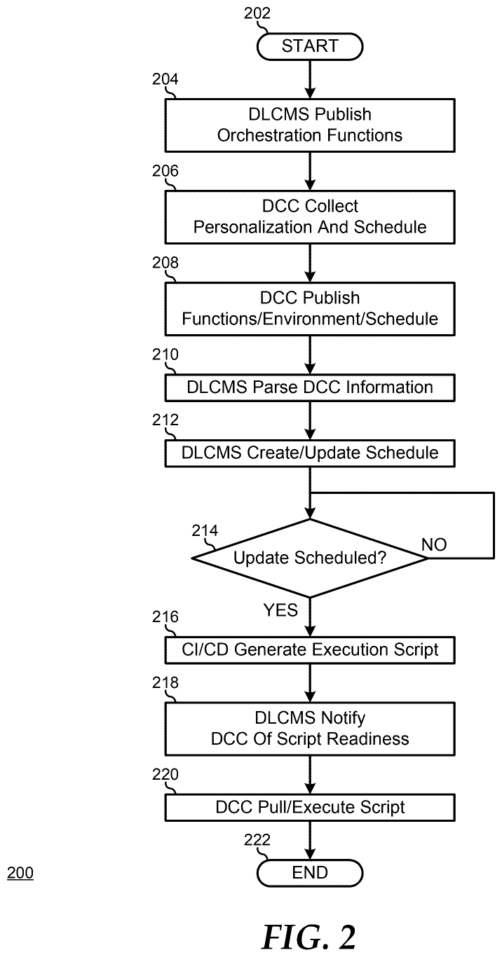

FIG. 2 illustrates a method 200 for dynamic and contextual lifecycle management of managed nodes of information handling systems, starting at block 202. A DLCMS complies a listing of the various lifecycle management update functions that are provided by the DLCMS and publishes the listing to the DCCs of the managed environments managed by the DLCMS in block 204. For example, the listing of lifecycle management update functions may include a listing of hardware platforms that may be updated by the DLCMS, including a listing of the individual hardware elements on the platforms that can be updated. The listing may further include a listing of firmware elements and software elements that may be updated by the DLCMS. Each managed environment then operates to determine an individual schedule and personalization for the desired lifecycle management updates that are suitable for the particular managed environment in block 206. For example, referring to FIG. 1, DCC 122 may operate to determine a desired schedule and a selection of hardware lifecycle updates, firmware lifecycle updates, and software lifecycle updates for platforms 124 from the listing of the lifecycle management update functions that are provided by DLCMS 112. In another example, cloud service DCC 116 may operate to determine a desired schedule and a selection of software lifecycle updates for services 132 from the listing of the lifecycle management update functions that are provided by DLCMS 112.

In block 208, the DCCs for the various managed environments publish their selected schedules and selected lifecycle management update functions back to the DLCMS. In a particular embodiment, the publication back to the DLCMS may include information related to the managed environment's desired update execution environment, such as an Ansible update environment, or the like. In block 210, the DLCMS parses the selected schedules and lifecycle management update functions from each of the DCCs, and then creates update schedules and update tables with the selected functions for each of the DCCs in block 212. A decision is made as to whether or not a lifecycle management update is scheduled for a managed environment in decision block 214. If not, then the “NO” branch of decision block 214 is taken and the method loops back to the decision block until an update is scheduled. Then, the “YES” branch of decision block 214 is taken and the DLCMS directs a CI/CD pipeline to generate an execution script and update package for the scheduled managed environment in block 216. In block 218, the DLCMS notifies the DCC associated with the scheduled managed environment that the script and update package are available, the DCC pulls the script and update package and executes the lifecycle management update in block 220, and the method ends in block 222.

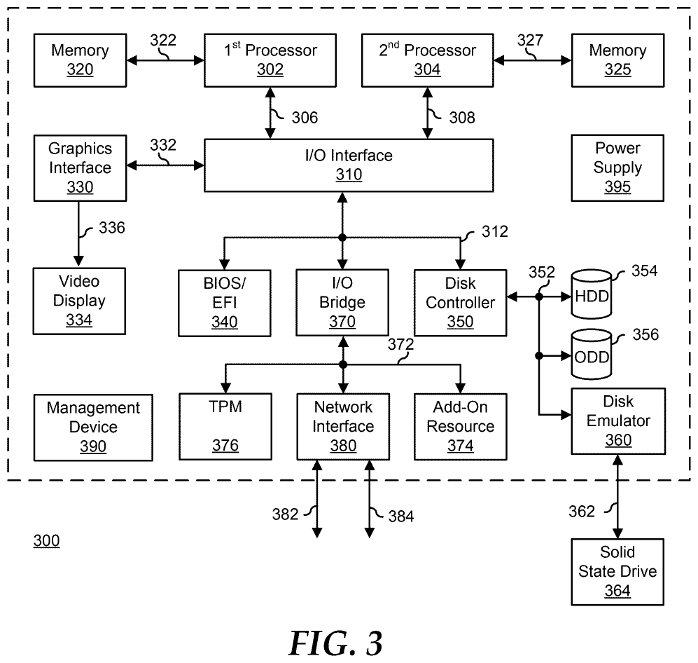

FIG. 3 illustrates a generalized embodiment of an information handling system 300 similar to information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 where peripheral interface 372 and the I/O channel are of the same type, and the I/O bridge translates information from a format suitable to the I/O channel to a format suitable to the peripheral channel 372 where they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 where the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system, comprising:
a memory to store machine-executable code; and
a processor to execute the code, the processor configured to create a listing of a plurality of management functions, to receive a subset of the management functions, and to create an execution script based on the subset of the management functions.

2. The information handling system of claim 1, wherein the processor is further configured to publish the listing of the management functions to a managed system.

3. The information handling system of claim 2, wherein the subset of the management functions are received from the managed system.

4. The information handling system of claim 3, wherein the processor is further configured to receive an update schedule from the managed system.

5. The information handling system of claim 4, wherein the processor is further configured to determine that a time associated with the update schedule has elapsed.

6. The information handling system of claim 5, wherein the processor is further configured to provide the execution script to the managed system in response to determining that the time associated with the update schedule has elapsed.

7. The information handling system of claim 5, wherein the processor is further configured to provide an indication to the managed system that the execution script is available in response to determining that the time associated with the update schedule has elapsed.

8. The information handling system of claim 7, wherein the processor is further configured to receive a request for the execution script in response to providing the indication that the execution script is available, and to provide the execution script to the managed system in response to the request.

9. The information handling system of claim 5, wherein creating the execution script is in response to determining that the time associated with the update schedule has elapsed.

10. The information handling system of claim 1, wherein the execution script includes at least one of a hardware update, a firmware update, and a software update.

11. A method, comprising:
creating, by a hardware processor, a listing of a plurality of management functions;
receiving a subset of the management functions; and
creating an execution script based on the subset of the management functions.

12. The method of claim 11, further comprising publishing the listing of the management functions to a managed system.

13. The method of claim 12, further comprising receiving the subset of the management functions from the managed system.

14. The method of claim 13, further comprising receiving an update schedule from the managed system.

15. The method of claim 14, further comprising determining that a time associated with the update schedule has elapsed.

16. The method of claim 15, further comprising providing the execution script to the managed system in response to determining that the time associated with the update schedule has elapsed.

17. The method of claim 15, further comprising providing an indication to the managed system that the execution script is available in response to determining that the time associated with the update schedule has elapsed.

18. The method of claim 17, further comprising:
receiving a request for the execution script in response to providing the indication that the execution script is available; and
providing the execution script to the managed system in response to the request.

19. The method of claim 15, wherein creating the execution script is in response to determining that the time associated with the update schedule has elapsed.

20. An information handling system, comprising:
a memory to store machine-executable code; and
a processor to execute code, the processor configured to create a listing of a plurality of management functions, to receive a subset of the management functions, to create an execution script based on the subset of the management functions, and providing the execution script to a managed system;
wherein the execution script includes at least one of a hardware update, a firmware update, and a software update.
